(19) United States
(12) Patent Application Publication
(10) Pub. No.: US 2007/0072162 A1
(43) Pub. Date: Mar. 29, 2007

(54) Audio-enabled marketing and memorabilia device

(76) Inventor: Julie Honadel, Hollywood, CA (US)

Correspondence Address: TOPE-MCKAY & ASSOCIATES, 23852 PACIFIC COAST HIGHWAY #311, MALIBU, CA, 90265, US

(21) Appl. No.: 11/521,812

(22) Filed: Sep. 15, 2006

Related U.S. Application Data
(60) Provisional application No. 60/717,709, filed on Sep. 15, 2005.

(51) Int. Cl. G09B 5/00

(52) U.S. Cl. 434/317

(57) ABSTRACT

Described is an audio-enabled marketing and memorabilia device. The device comprises an image and related text attached with a substantially planar sheet. A sound-generating mechanism is also attached with the substantially planar sheet. The sound-generating mechanism has a sound signal stored therein that corresponds to the text, such that when activated, the sound-generating mechanism audiblizes the text. Thus, using the audio-enabled device, a user can coordinate an image, related text, and related sound to memorialize a moment in time.

### PRIORITY CLAIM

The present invention is a non-provisional patent application, claiming the benefit of priority of U.S. Provisional Patent Application No. 60/717,709, filed on Sep. 15, 2005, entitled, “Method and trend of marketing compilations comprising of visual and audio elements of commercially viable intellectual property of multi-media entertainment communicated through a paper based presentation for memorabilia and promotional purposes.”

### BACKGROUND OF THE INVENTION

(1) Field of Invention

The present invention relates to a multi-media device, and more particularly to an audio-enabled marketing and memorabilia product that includes an illustration and an audio device that emits an audio signal related to the illustration.

(2) Description of Related Art

Various marketing and memorabilia-based products have long been known in the art. For example, when a new movie is released by a production company, the production company often prints posters and pamphlets to promote the new movie. The posters and pamphlets typically include illustrations and promotional content that is related to the new movie. Thus, other materials illustrate certain aspects of the item that is to be memorialized.

Examples of other promotional prior art can be seen through (1) production company movie trailers and previews viewed on large cinema screens or televisions for brief and instantaneous pleasure and allure; (2) outdoor furniture such as large, steel-framed billboards and/or benches that hold still photo publicity images of new and old mass-media releases; (3) mobile units with exterior print advertisements such as public transportation billboards, personal vehicles, and scooters; and (4) hand-held print material having only promotional-related images. Examples of such hand-held print material include cards, which have been used as a marketing and/or memorabilia-based product. While a card is functional for illustrating the item that is to be promoted and/or memorialized, typical cards do not go beyond illustrations. All of the above forms of prior art are limited in that they do not encompass multiple forms of media. In other words, the prior art does not also include other effects, such as audio signals.

Thus, a continuing need exists for an audio-enabled marketing and memorabilia device that includes both illustrations and related audio signals.

### SUMMARY OF INVENTION

The present invention relates to an audio-enabled device. The device comprises a substantially planar sheet with an image attached thereto. A sound-generating mechanism is attached with the substantially planar sheet. The sound-generating mechanism includes a sound signal stored therein that corresponds to the image, such that when activated, the sound-generating mechanism audiblizes the sound signal. Using the audio-enabled device, a user can coordinate an image and related sound to memorialize a moment in time.

In another aspect, the present invention further comprises written text attached with the substantially planar sheet. The text is related to the image. Additionally, the sound signal stored in the sound-generating mechanism corresponds to the text, such that when activated, the sound-generating mechanism audiblizes the text.

In another aspect, the image includes a character and the sound signal is an actual audio recording of a phrase related to the text and the image, as spoken by the character.

In another aspect, the image is a still-shot taken from a movie and the text is a particular phrase used in the movie.

Additionally, the substantially planar sheet is formed of paper.

In another aspect, the substantially planar sheet has a front cover and a back cover. The front cover and back cover share a common edge and are closable to form an interior portion and an exterior portion of the device.

In yet another aspect, the present invention further comprises a plurality of substantially planar sheets, where each sheet including date information pertaining to a particular month such that a collection of the planar sheets operates as a calendar. Additionally, each sheet of the plurality of planar sheets includes a different image and related text. Furthermore, the sound-generating mechanism is configured to audiblize the text for each of the planar sheets, whereby a user can use the device as a calendar and selectively audiblize text corresponding to a particular month.

In another aspect, the date information pertaining to a particular month includes a plurality of days represented by the particular month. Furthermore, the sound-generating mechanism is configured to audiblize a new phrase for each day of the plurality of days.

In yet another aspect, the present invention further comprises a plurality of substantially planar sheets, where the sheets each have four edges and share multiple edges to collectively form a box. Additionally, the sound-generating mechanism is concealed substantially within the box.

In another aspect, the present invention further comprises a plurality of substantially planar sheets, where the sheets have at least one edge and are bound together at the edge to collectively form a book.

Additionally, the sound-generating mechanism is formed to selectively record and replay an audio signal, thereby allowing a user to selectively record and reply the desired audio signal.

In yet another aspect, the present invention further comprises a compartment attached with the substantially planar sheet, the compartment being formed to hold an object therein.

In another aspect, the present invention also comprises a method using the marketing and memorabilia device described herein.

For example, the present invention includes a method for marketing using an audio-enabled marketing device. The method comprises acts of attaching an image with a substantially planar sheet; attaching text with the substantially planar sheet; attaching a sound-generating mechanism with the substantially planar sheet; and providing the device to an end user to promote the particular product. As with other aspects herein, the image is related to a particular product, the text is related to the particular product and the image, and the sound-generating mechanism has a sound signal stored therein that is an audible version of the text.

Additionally, the image is a still shot from a particular movie, the text is a phrase as spoken by a character in the movie, and the sound signal is an actual audio recording of the phrase as spoken by the character, thereby enabling a marketer to provide a user with an audio-enabled market device to market the particular movie.

Finally, as can be appreciated by one skilled in the art, the present invention also comprises a method for forming the device described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a device according to the present invention, showing the device embodied as a card and illustrating an interior portion of the card;

FIG. 2 is an illustration of the device according to the present invention, showing a front and back cover;

FIG. 3 is an illustration of the device according to the present invention, illustrating an audio device affixed with the card;

FIG. 4 is an illustration of the device according to the present invention, illustrating the device being incorporated into a calendar;

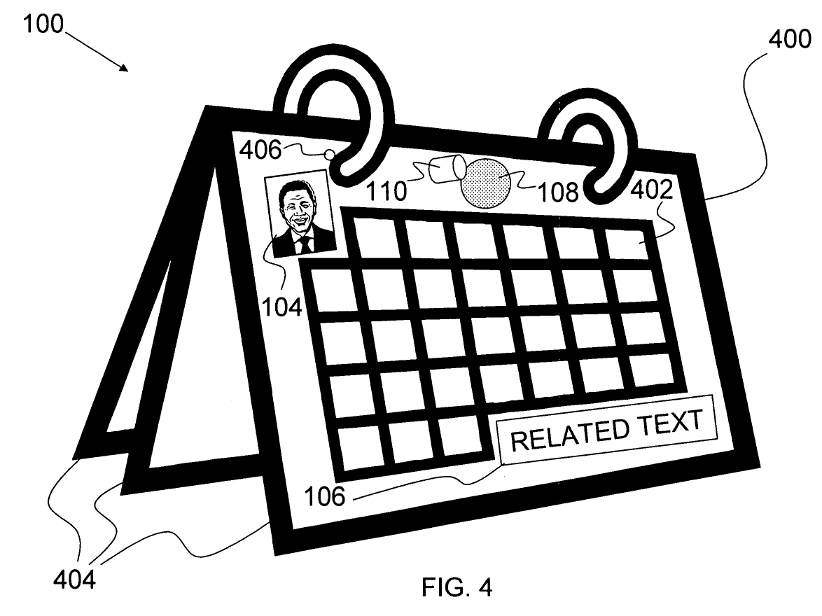

FIG. 5 is an illustration of the device according to the present invention, illustrating the device being incorporated into a box;

FIG. 6 is an illustration of the device according to the present invention, illustrating the device being incorporated into a book; and

FIG. 7 is a flow chart illustrating a marketing process using the audio-enabled marketing and memorabilia device.

### DETAILED DESCRIPTION

The present invention relates to an audio-enabled device, and more particularly to an audio-enabled marketing and memorabilia product that includes an illustration and an audio device that emits an audio signal related to the illustration. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels “left,” “right,” “front,” “back,” “top,” “bottom,” “forward,” “reverse,” “clockwise” and “counter-clockwise” have been used for convenience purposes only and are not intended to imply any particular fixed direction. Instead, they are used to reflect relative locations and/or directions between various portions of an object.

(1) Introduction

The present invention relates to an audio-enabled marketing and memorabilia device. The invention provides an apparatus and a method for targeting key tag-lines, famous one-liners, and memorable and endearing moments. The device can be used for entertainment structured materials through a paper-based presentation. The device blends an image, visual diction, and audio recognition of collective and related work, resulting in a multi-dimensional marketing and/or memorabilia product that is superior to the prior art.

Thus, the present invention provides a method for exploiting the intellectual property of movies and multi-media entertainment by harvesting or gleaming cultural icons, slogans, phrases, literature, musical lyrics, and/or scenes from movies, plays, theater, interviews, public appearances, television, concerts, private events, and organizations. Other intellectual property expressions include satirical representations, political and social commentary, and/or like images and phrases. The expressions are integrated in a unique compilation that comprises visual and audio components. Therefore, the present invention provides a still representation of a moment and sound, revealed concurrently and being communicated through a paper-based presentation. Such presentations include greeting cards, calendars, publications, books, and/or like items, creating a hybrid of new promotional memorabilia.

An advantage of the present invention includes its personal portability. The present invention is formed in a conveniently small size, and as such, can be handed out inexpensively as a movie screening gift and/or as a collectible card.

The present invention includes other advantages over marketing materials of the prior art, such as being easily manufactured and having the ability to be in the hands of the consumer at any time of the year (due to its small size). Thus, a consumer can be reminded of a particular product or service year-round. Additionally, because the present invention is a paper-based product, it provides ecological benefits through recycling and a less-harsh manufacturing method.

(2) Specific Aspects

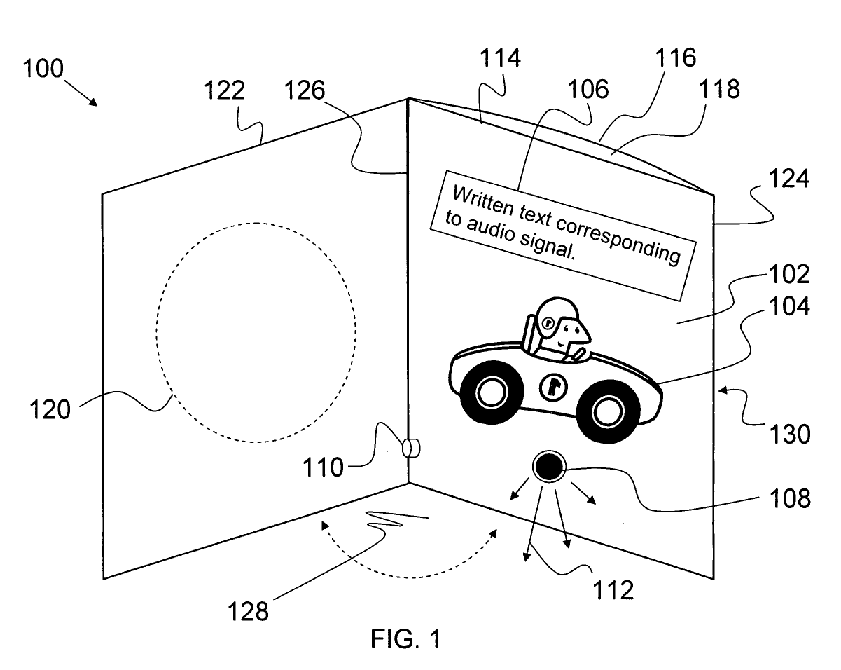

The present invention is an audio-enabled marketing and memorabilia device. The device can be a greeting card, or incorporated into other materials such as a calendar or book. In all aspects, as shown in FIG. 1, the device 100 includes a substantially planar sheet 102 with an image 104 attached thereto. The device 100 is formed of any suitably stable material, non-limiting examples of which include paper and plastic. However, for environmental reasons, it is desirable to produce the device in a manner such that it is primarily paper-based.

The image 104 can be attached with the planar sheet 102 through any suitable technique for affixing an image with an object, non-limiting examples of which include printing the image 104 directly onto the planar sheet 102 and using an adhesive to affix a pre-printed image onto the planar sheet 102. The image 104 is any suitable image that is used to promote or memorialize a particular product and/or moment, a non-limiting example of which includes a still photo image.

Additionally, text 106 related to the image 104 is affixed to the planar sheet 102. The text 106 related to the image 104 is any suitable text that is recognizably associated with the image 104, a non-limiting example of which includes printed verbiage spoken when the image 104 was taken as a still photo.

Finally, a sound-generating mechanism 108 is attached with the device 100. The sound-generating mechanism 108 includes a sound signal stored therein that corresponds to the text 106 and/or image 104. The sound signal is any suitable signal corresponding to the text 106 and/or image 104, a non-limiting example of which includes an authentic audio-recording of a quote related to the text 106 and/or image 104. Additionally, the sound-generating mechanism 108 includes an actuator 110 to activate the sound-generating mechanism 108 and cause it to generate a sound 112. The actuator 110 is any suitable mechanism or device for activating the sound-generating mechanism 108, non-limiting examples of which include a button, a light sensor, and a slide switch. When activated, the sound-generating mechanism 108 audiblizes the text 106, thereby coordinating the image 104, related text 106, and related sound 112 to memorialize a moment in time.

As a non-limiting example, when marketing a particular movie, the image 104 is a still-shot taken from the movie and the text 106 includes a particular phrase used in the movie. When the sound-generating mechanism 108 is activated, it audiblizes the particular phrase to create a multi-media driven, promotional marketing and memorabilia product.

Other exemplary uses of the present invention include press kits, portfolios, demonstrations, etc. for production companies, individual actors, and others to market themselves or their projects to obtain distribution and/or production deals. In this aspect, the present invention can be used as a marketing tool to trigger interest in the development of a particular multi-media product. By way of example, a small independent film company could embody a still image and catch phrase from a film short that the company produced, into a device according to the present invention. During a studio or distribution presentation meeting, the device could then be presented to the attendees as a marketing tool to develop and prompt a continued interest in the film.

The sound-generating mechanism 108 can be any suitable mechanism or device for storing and playing a sound signal. For example, the sound-generating mechanism 108 includes a power source, a sound chip for storing and playing a sound signal, and a speaker for audiblizing the sound signal. The sound-generating mechanism 108 is affixed with the device in any suitable manner for affixing one object with another. As a non-limiting example, the device 100 includes a first wall 114 and a second wall 116, which a space formed therebetween.

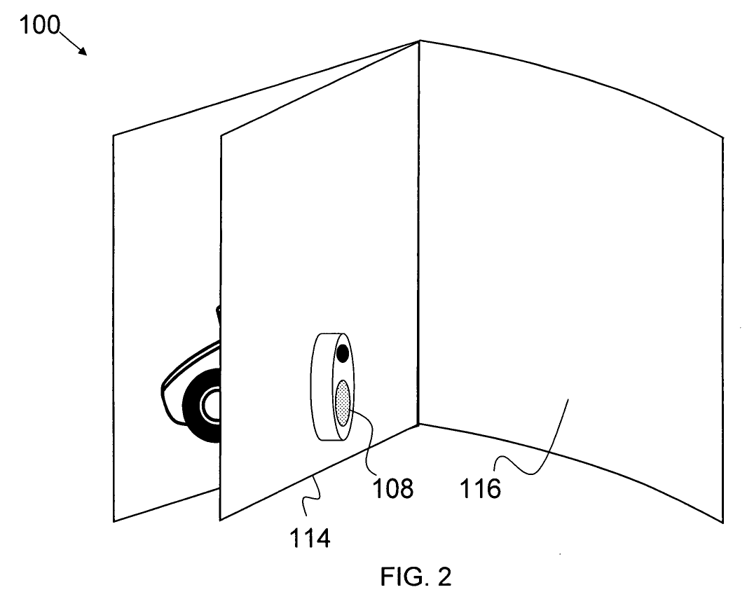

FIG. 2 is an illustration of the device 100 with the first wall 114 and the second wall 116 separated for illustrative purposes. In this aspect, the sound-generating mechanism 108 is attached with the device 100 such that it is positioned substantially between the first wall 114 and the second wall 116. By positioning the sound-generating mechanism 108 between the first 114 and second walls 116, the actuator may be clearly visible (shown in FIG. 1) while the sound-generating mechanism 108 is hidden within the paper product or unseen and activated by motion of the product.

The device 100 can be used in numerous manners as a paper-based, promotional and souvenir product. For example, the device 100 includes at least one open area 120 to manually write or place any additional elements, such as greetings and salutations. As another example, the open area 120 can be used for autographs from the creators, artists, etc. of the intellectual property that is being promoted and/or memorialized.

As can be appreciated by one skilled in the art, the device 100 can be incorporated in a wide array of products for use as a promotional product. For example and as illustrated in FIGS. 1 through 3, the device 100 is incorporated into a greeting card for promotional and marketing purposes, gifts, wedding announcements, baby announcements, etc.

In this aspect, as shown in FIG. 1, the device 100 has a front cover 122 and a back cover 124. The front cover 122 and back cover 124 share a common edge 126. Using the common edge 126, the device 100 is closable to form an interior portion 128 and an exterior portion 130. The interior portion 128 can be enclosed within the device 100 when closed, leaving the exterior portion 130 facing an exterior of the device.

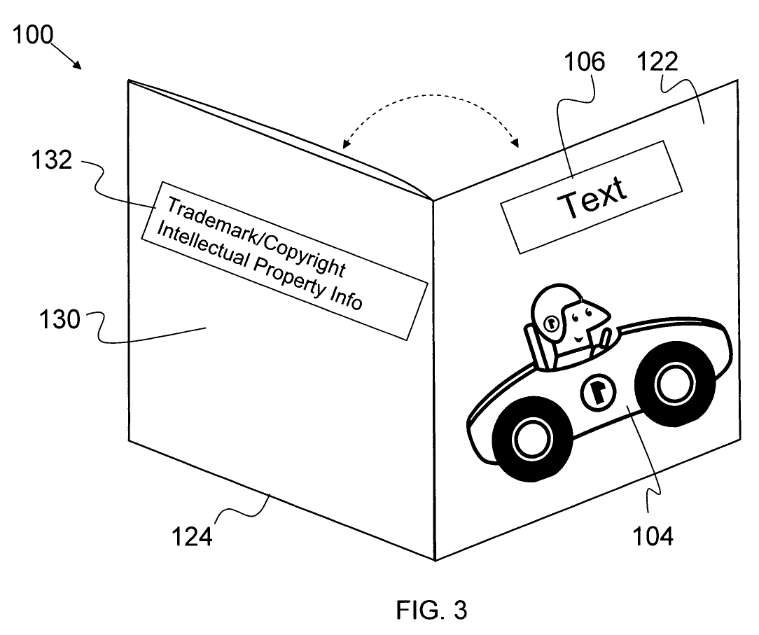

FIG. 3 illustrates the exterior portion 130 of the device 100 (in an open position). As with the interior portion, an image 104 and related text 106 can be attached with the front cover 122. The text 106 can be the audiblized text or any other related text, such as the title of a movie.

The rear cover 124 also includes space for the inclusion of any related material. As a non-limiting example, intellectual property information 132 can be attached with the rear cover 124.

In another aspect, the device 100 is formed such that it functions as a calendar 400. As with most calendars, the calendar 400 represents the days 402 in any given month. Additionally, the calendar 400 includes a plurality of months 404 (collectively representing a year). Unlike calendars of the prior art, the present invention includes an image 104, related text 106, and a sound-generating mechanism 108. Using the actuator 110, the sound-generating mechanism 108 audibilizes a sound that is related to the image 104 and/or text 106.

Additionally, each of the plurality of months 404 includes a different image 104 and related text 106. Furthermore, the sound-generating mechanism 108 is configured to audiblize the sound corresponding to the image 104 and text 106 represented by the different months. For example, January could include an image taken from the movie Casablanca, a Warner Brothers movie. The sound generated could be the famous line, “Here's looking at you kid.” The text 106 could be a print of that phrase, or other related text. The month of February could include another image from the movie Casablanca with another Casablanca specific phrase generated for that month. Thus, the calendar 400 can be targeted to a single intellectual property title, such as to a single movie. Alternatively, to market and/or memorialize a wider array of properties, each month could include a different item altogether. For example, while January includes material related to Casablanca, February could include material related to Batman, another Warner Brothers movie. Thus, the device 100 serves as a promotional product showcasing a company's portfolio.

The sound-generating mechanism 108 is positioned and attached with the calendar 400 such that it can produce a distinct sound corresponding to the display of a particular month 404. For example, a plurality of sound-generating mechanisms 108 are included, one attached with each month's sheet. Alternatively, a single sound-generating mechanism 108 can be used to generate the sounds for each month 404. For example, a distinct actuator 110 can be used for each month 404. In another aspect, a contact 406 can be included within each month's 404 sheet such that by displaying a particular month 404, the contact 406 completes a circuit to indicate that the particular month 404 is being displayed. Thus, when the actuator 110 is actuated, the sound-generating mechanism 108 audiblizes the sound corresponding to the image 104 and text 106 that are represented on that particular month's 404 sheet.

In another aspect, the calendar 400 can be formed such that the sound-generating mechanism 108 audiblizes a new phrase, etc., for each day of the month. For example, the calendar 400 can be an advent calendar that includes a verbal countdown for each day until Christmas, with each day having a new phrase. As another example, the calendar 400 can be personalized to countdown holidays, birthdays, vacations, baby due dates, etc. As can be appreciated by one skilled in the art, the actuator 110 can include a plurality of switches corresponding to each day to enable a new phrase being audiblized for each day. For example, a touch switch can be positioned proximate each day of the month.

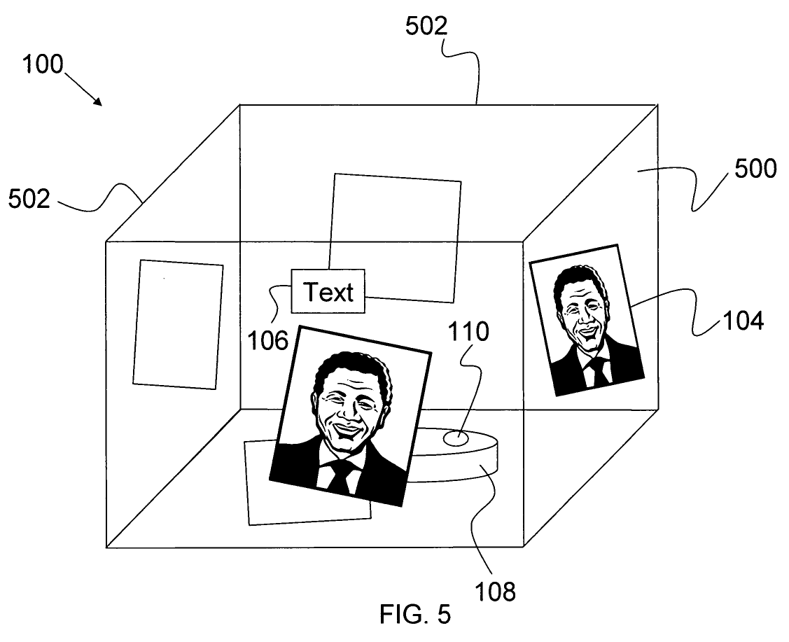

As another example, as shown in FIG. 5, the device 100 can be formed into a small box 500. In this aspect, the device 100 includes a plurality of substantially planar sheets 502, each having four edges and sharing multiple edges to collectively form the box 500. The box 500 includes at least five sheets 502 with still images 104 and related text 106 of multi-media-based intellectual property affixed with at least one of the five sheets 502. The sound-generating mechanism 108 is attached with the box 500 such that it is substantially within the box 500. In addition to other traditional switch mechanisms, the actuator 110 can also be configured to be actuated by motion or light (i.e., a motion sensor or light sensor). For example, lifting a lid of the box to expose its interior would allow light to enter the interior of the box. If a motion sensor is used as the actuator 110, the light would actuate the sound-generating mechanism to cause it to audiblize the sound signal stored therein. As above, the sound signal includes a catch phrase or other dialogue that is related to the image 104.

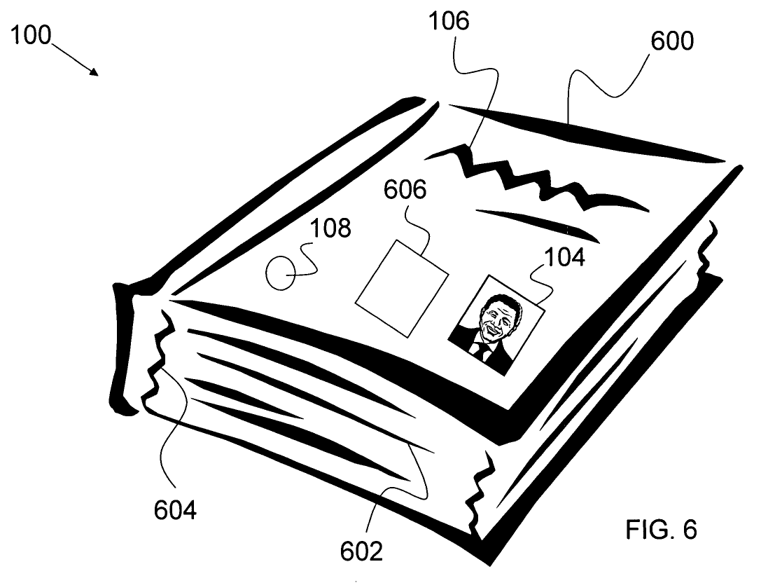

In yet another aspect, as shown in FIG. 6, the device 100 can be incorporated into a book 600. In this aspect, the device includes a plurality of substantially planar sheets 602. The sheets have at least one edge 604 and are bound together at that edge 604 to collectively form the book 600.

On its cover and/or in its pages, the book 600 includes the image 104, related text 106, and a sound-generating mechanism 108. The book 600 can be formed for use with any suitable medium. For example, the book 600 can be applied to the entertainment industry, or it can be personalized for memorabilia related purposes. When personalizable, the sound-generating mechanism 108 is capable of recording and replaying an audio signal. Thus, a user can selectively record and reply the desired verbiage. For example, the book 600 can be used as a baby book where the baby's first word (or other baby utterance) is recorded into the book 600. A compartment 606 is also included to contain related material therein. For example, the compartment 606 can be used to hold a baby's first lock of hair, etc.

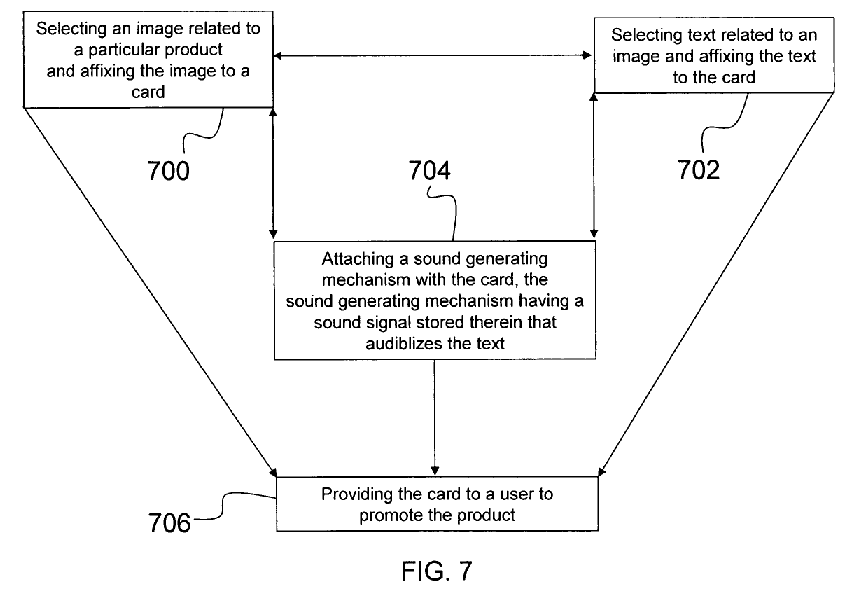

As can be appreciated by one skilled in the art, the present invention can be used to market a wide array of products. When marketing the products, particular acts are undertaken to coordinate the present invention with the product. As shown in FIG. 7, an image is selected and affixed with the device that is related to a particular product 700. The image is used to increase recognition with that particular product, such as a particular movie. Related text is also selected and affixed with the device 702. As described above, the related text is related to the particular product and can be text associated with the particular image. A sound-generating mechanism 704 is also attached with the device. The sound-generating mechanism is used to store an audiblized version of the text, or other related text. Finally, the device is provided to an end user 706 to promote the particular product. Thus, a consumer can be reminded of a particular product or service year-round.

What is claimed is:

1. An audio-enabled device, comprising:
a substantially planar sheet;
an image attached with the substantially planar sheet; and
a sound-generating mechanism attached with the substantially planar sheet, the sound-generating mechanism having a sound signal stored therein that corresponds to the image, such that when activated, the sound-generating mechanism audiblizes the sound signal, whereby using the audio-enabled device, a user can coordinate an image and related sound to memorialize a moment in time.

2. An audio-enabled device as set forth in claim 1, further comprising written text attached with the substantially planar sheet, the text being related to the image, and where the sound signal stored in the sound-generating mechanism corresponds to the text, such that when activated, the sound-generating mechanism audiblizes the text, whereby using the audio-enabled device, a user can coordinate an image, related text, and related sound to memorialize a moment in time.

3. An audio-enabled device as set forth in claim 2, wherein the image includes a character and the sound signal is an actual audio recording of a phrase related to the text and the image, as spoken by the character.

4. An audio-enabled device as set forth in claim 3, where the image is a still-shot taken from a movie and the text is a particular phrase used in the movie.

5. An audio-enabled device as set forth in claim 4, wherein the substantially planar sheet is formed of paper.

6. An audio-enabled device as set forth in claim 5, wherein the substantially planar sheet has a front cover and a back cover, the front cover and back cover sharing a common edge and being closable to form an interior portion and an exterior portion of the device.

7. An audio-enabled device as set forth in claim 5, further comprising a plurality of substantially planar sheets, each sheet including date information pertaining to a particular month such that a collection of the planar sheets operates as a calendar, where each sheet of the plurality of planar sheets includes a different image and related text, and wherein the sound-generating mechanism is configured to audiblize the text for each of the planar sheets, whereby a user can use the device as a calendar and selectively audiblize text corresponding to a particular month.

8. An audio-enabled device as set forth in claim 7, wherein the date information pertaining to a particular month includes a plurality of days represented by the particular month, and where the sound-generating mechanism is configured to audiblize a new phrase for each day of the plurality of days.

9. An audio-enabled device as set forth in claim 5, further comprising a plurality of substantially planar sheets, the sheets each having four edges and sharing multiple edges to collectively form a box, such that the sound-generating mechanism is concealed substantially within the box.

10. An audio-enabled device as set forth in claim 9, further comprising a plurality of substantially planar sheets, the sheets having at least one edge and being bound together at the least one edge to collectively form a book.

11. An audio-enabled device as set forth in claim 10, wherein the sound-generating mechanism is formed to selectively record and replay an audio signal, thereby allowing a user to selectively record and reply the desired audio signal.

12. An audio-enabled device as set forth in claim 11, further comprising a compartment attached with the substantially planar sheet, the compartment being formed to hold an object therein.

13. An audio-enabled device as set forth in claim 1, wherein the substantially planar sheet has a front cover and a back cover, the front cover and back cover sharing a common edge and being closable to form an interior portion and an exterior portion of the device.

14. An audio-enabled device as set forth in claim 1, further comprising a plurality of substantially planar sheets, each sheet including date information pertaining to a particular month such that a collection of the planar sheets operates as a calendar, where each of the plurality of planar sheets includes a different image and related text, and wherein the sound-generating mechanism is configured to audiblize the text for each of the planar sheets, whereby a user can use the device as a calendar and selectively audiblize text corresponding to a particular month.

15. An audio-enabled device as set forth in claim 14, wherein the date information pertaining to a particular month includes a plurality of days represented by the particular month, and where the sound-generating mechanism is configured to audiblize a new phrase for each of the plurality of days.

16. An audio-enabled device as set forth in claim 1, further comprising a plurality of substantially planar sheets, the sheets each having four edges and sharing multiple edges to collectively form a box, such that the sound-generating mechanism is concealed substantially within the box.

17. An audio-enabled device as set forth in claim 1, further comprising:
a plurality of substantially planar sheets, the sheets having at least one edge and being bound together at the edge to collectively form a book; and
a compartment attached with at least one of the planar sheets, the compartment being formed to hold an object therein.

18. An audio-enabled device as set forth in claim 1, wherein the sound-generating mechanism is formed to selectively record and replay an audio signal, thereby allowing a user to selectively record and reply the desired audio signal.

19. A method for marketing using an audio-enabled marketing device, the method comprising acts of:
attaching an image with a substantially planar sheet, the image being related to a particular product;
attaching text with the substantially planar sheet, the text being related to the particular product and the image;
attaching a sound-generating mechanism with the substantially planar sheet, the sound-generating mechanism having a sound signal stored therein, the sound signal being an audible version of the text; and
providing the device to an end user to promote the particular product.

20. A method as set forth in claim 19, wherein in the acts of attaching an image, attaching text, and attaching a sound-generating mechanism, the image is a still shot from a particular movie, the text is a phrase as spoken by a character in the movie, and the sound signal is an actual audio recording of the phrase as spoken by the character, thereby enabling a marketer to provide a user with an audio-enabled market device to market the particular movie.

21. A method for marketing using an audio-enabled marketing device, the method comprising an act of providing a device to an end user to promote a particular product, the device comprising:
a substantially planar sheet;
an image attached with the substantially planar sheet, the image being related to the particular product;
text attached with the substantially planar sheet, the text being related to the particular product and the image; and
a sound-generating mechanism attached with the substantially planar sheet, the sound-generating mechanism having a sound signal stored therein that corresponds to the text, such that when activated, the sound-generating mechanism audiblizes the text, whereby using the audio-enabled device, a user can coordinate an image, related text, and related sound to memorialize a moment in time and thereby be reminded of the particular product.

22. A method as set forth in claim 21, wherein the image is a still shot from a particular movie, the text is a phrase as spoken by a character in the movie, and the sound signal is an actual audio recording of the phrase as spoken by the character, thereby enabling a marketer to provide a user with the audio-enabled marketing device to market the particular movie.
